(19) United States
(12) Patent Application Publication
(10) Pub. No.: US 2025/0117971 A1
(43) Pub. Date: Apr. 10, 2025

(54) VIDEO DIFFUSION USING SUPERPOSITION NETWORK ARCHITECTURE SEARCH

(71) Applicant: ADOBE INC., SAN JOSE, CA (US)

(72) Inventors: Feng Liu, Beaverton, OR (US); Zhengang Li, Boston, MA (US); Yan Kang, Kirkland, WA (US); Yuchen Liu, Mountain View, CA (US); Difan Liu, San Jose, CA (US); Tobias Hinz, Campbell, CA (US)

(21) Appl. No.: 18/816,693

(22) Filed: Aug. 27, 2024

Related U.S. Application Data
(60) Provisional application No. 63/588,424, filed on Oct. 6, 2023.

(51) Int. Cl. G06T 11/00; G06T 3/4046; G06T 3/4053; G06V 10/774; G06V 10/776; G06V 10/82

(52) U.S. Cl. CPC G06T 11/00; G06T 3/4046; G06T 3/4053; G06V 10/774; G06V 10/776; G06V 10/82

(57) ABSTRACT

A method, apparatus, non-transitory computer readable medium, apparatus, and system for video generation include first obtaining a training set including a training video. Then, embodiments initialize a video generation model, sample a subnet architecture from an architecture search space, and a identify a subset of the weights of the video generation model based on the sampled subnet architecture. Subsequently, embodiments train, based on the training video, a subnet of the video generation model to generate synthetic video data. The subnet includes a subset of the weights of the video generation model.

### CROSS-REFERENCE TO RELATED APPLICATION

This U.S. non-provisional application claims priority under 35 U.S.C. § 119 to U.S. Provisional Patent Application No. 63/588,424, filed on Oct. 6, 2023, in the United States Patent and Trademark Office, the disclosure of which is incorporated by reference herein in its entirety.

### BACKGROUND

The following relates generally to image processing, and more specifically to video generation. Image processing is a type of data processing that involves the manipulation of an image to achieve a desired output, typically utilizing specialized algorithms and techniques. Image processing techniques are also used for image generation. For example, machine learning (ML) techniques have been applied to create generative models that can produce new image content. One use for generative AI is to create images based on an input prompt. This task is often referred to as a “text to image” task or simply “text2img”, though image, video, and other types of prompts can be used. ML models including Generative Adversarial Networks (GANs) and Variational Autoencoders (VAEs) have been adapted to generate pixel data to create novel images. Newer approaches such as denoising diffusion probabilistic models (DDPMs) iteratively refine generated images based on a guidance, such as a text prompt.

Recently, image generation models have been adapted for use in video generation, by using the models to generate frames of videos. However, generating enough frames to form a video can have significant cost in terms of computation. For example, on a consumer-level graphics card, generation of a single 512×512 image may take upwards of 1-10 minutes. More powerful computational resources, such as dedicated server GPUs, may reduce this time. Still, users are limited by their configurability of the generator model. In certain scenarios, users may aim to specify a desired generation time, video resolution, or another specific parameter, which involves the use of dedicated, separately-trained models tailored for each set of target parameters.

### SUMMARY

Embodiments of the inventive concepts described herein include systems and methods for generating videos. Embodiments include a video generation apparatus with a video generation model that is configured to form different subnet models for different usages. The video generation model can be referred to as a “super-net”, and includes weights that are shared between the various subnets, a concept referred to as “superposition.” The video generation model is trained during multiple training iterations, with different subnets selected for each training iteration. Subnets may be differentiated by the percentage of channels utilized within a block, the types of layers utilized within a block, by their target output resolution, or by some combination thereof. When it is time to generate a video, a subnet is selected according to computation constraints using a dynamic cost sampling algorithm. Embodiments can either extract that particular subnet for deployment, or form a subnet within the super-net in an ad-hoc process via, e.g., a layer mask.

A method, apparatus, non-transitory computer readable medium, and system for video generation are described. One or more aspects of the method, apparatus, non-transitory computer readable medium, and system include obtaining a training set including a training video; initializing a video generation model; sampling a subnet architecture from an architecture search space; identifying a subset of weights of the video generation model based on the sampled subnet architecture; and training, based on the training video, a subnet of the video generation model to generate synthetic video data, wherein the subnet includes the subset of the weights of the video generation model.

A method, apparatus, non-transitory computer readable medium, and system for video generation are described. One or more aspects of the method, apparatus, non-transitory computer readable medium, and system include obtaining an input prompt, a target video resolution, and a target performance parameter; selecting a subnet of a video generation model based on the target video resolution and the target performance parameter; and generating, using the subnet of the video generation model, synthetic video data based on the input prompt, wherein the synthetic video data has the target video resolution.

An apparatus, system, and method for video generation are described. One or more aspects of the apparatus, system, and method include at least one processor; at least one memory storing instructions executable by the at least one processor; and a video generation model comprising parameters stored in the at least one memory, wherein the video generation model includes a plurality of individually trained subnets trained to generate synthetic video data based on an input prompt and a target video resolution.

### BRIEF DESCRIPTION OF THE DRAWINGS

FIG. 1 shows an example of a video generation system according to aspects of the present disclosure.

FIG. 2 shows an example of a video generation apparatus according to aspects of the present disclosure.

FIG. 3 shows an example of a video generation architecture according to aspects of the present disclosure.

FIG. 4 shows an example of a diffusion pipeline according to aspects of the present disclosure.

FIG. 5 shows an example of a training pipeline according to aspects of the present disclosure.

FIG. 6 shows an example of subnet sampling according to aspects of the present disclosure.

FIG. 7 shows an example of a method for training a video generation model according to aspects of the present disclosure.

FIG. 8 shows an example of an inference pipeline for video generation according to aspects of the present disclosure.

FIG. 9 shows an example of a method for providing a video to a user with generation time constraints according to aspects of the present disclosure.

FIG. 10 shows an example of a method for generating a synthetic video according to aspects of the present disclosure.

FIG. 11 shows an example of a computing device according to aspects of the present disclosure.

### DETAILED DESCRIPTION

Image processing is a fundamental aspect of computer vision, focusing on the manipulation, analysis, and interpretation of visual data. With the development of advanced algorithms and computational techniques, image processing has expanded to include image generation. Generative models, in particular, have enabled the synthesis of realistic images based on varied inputs.

Building on the foundation of image generation, the principles have been extended to video generation. In this context, adaptations such as temporal encoding have been introduced to maintain coherence and continuity across sequential frames. Temporal coherence encompasses aspects such as consistent lighting and consistent character and object models.

While the research into generating high-quality videos is continuously evolving, the cost in terms of memory utilization and computational overhead remains very large. One conventional approach to this issue is to create multiple, separately-trained models. This approach addresses the memory constraints that arise during training. The different models handle different aspects of video generation, such as spatial detail enhancement, temporal coherence, and motion prediction. This segmented approach, while beneficial for modular development and specialized processing, introduces challenges in integrating these components seamlessly.

In the separate-model approach, an output video is iteratively built through upsampling and refinement. However, the coordination between separately trained models can lead to inefficiencies, increased computational overhead, and potential inconsistencies in video output due to the varied capabilities and performance of each model. That is, despite this modular approach, forming a cohesive video output still uses a significant amount of computational resources, as the entirety of the model pipeline's parameters are used during inference. Furthermore, training these models on high-resolution data becomes prohibitive due to the memory constraints of currently available GPUs. There is a need for more integrated and efficient approaches to video generation.

Embodiments of the present disclosure improve on existing video generation systems by providing a unified “super-net” video generation model from which different sub-models may be deployed without retraining. Embodiments include a video generation model including a set of parameters, from which different subsets of parameters are selected for training and inference. During training, this enables embodiments to minimize memory usage, as the training data can be selected according to the subnet being trained. During inference, this allows different subnets to be extracted for different target computation requirements.

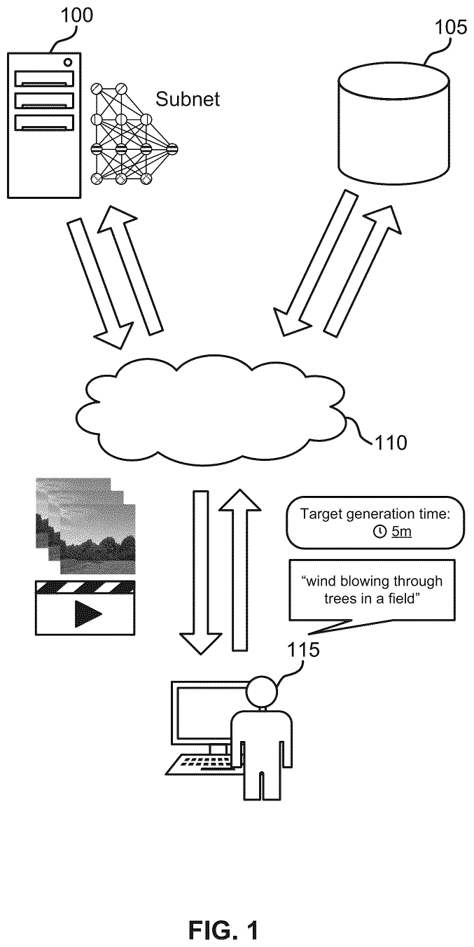

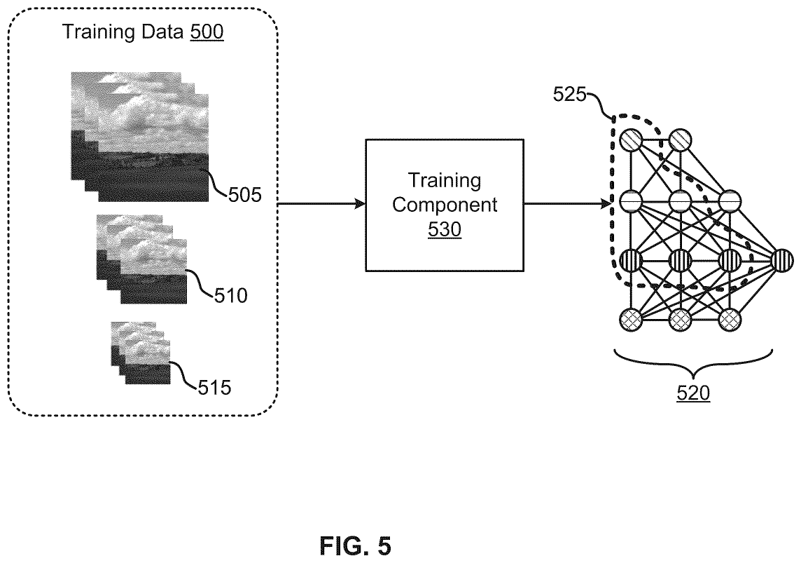

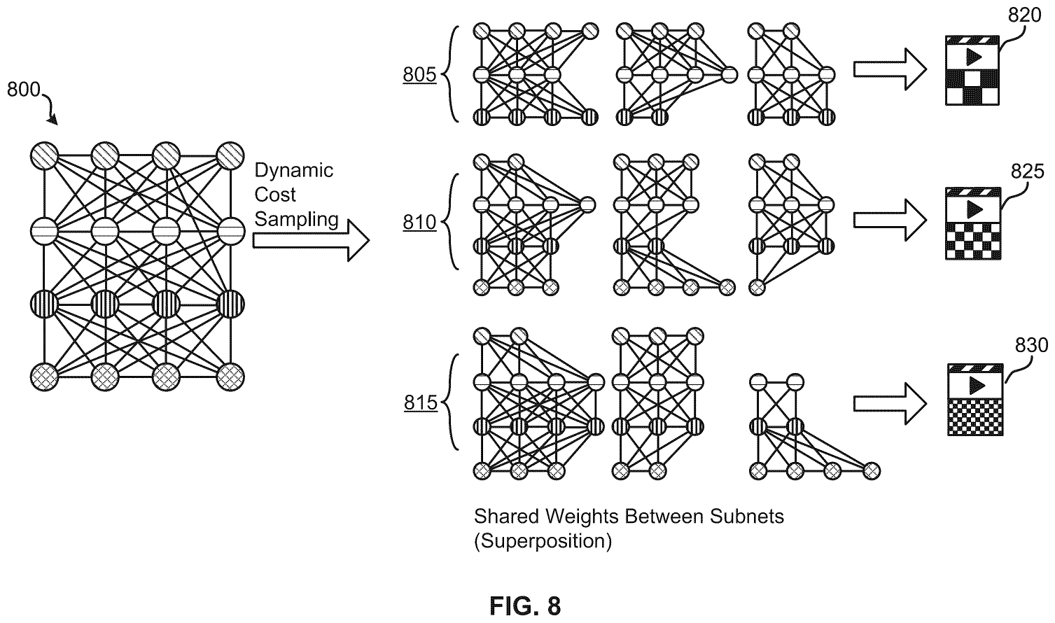

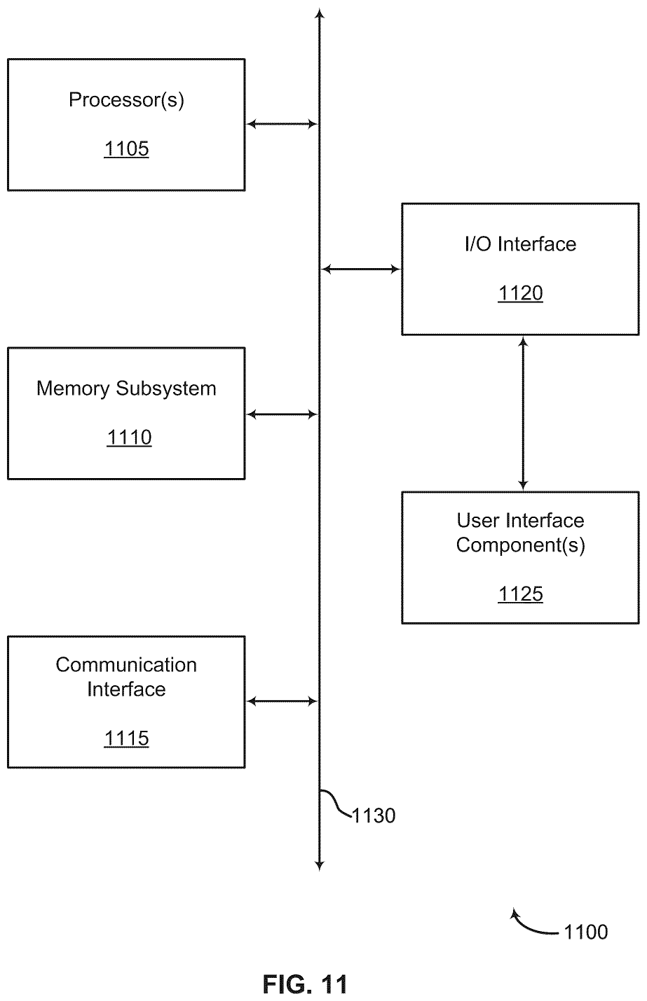

A video generation system is described with reference to FIGS. 1-4. Methods for training a video generation apparatus are described with reference to FIGS. 5-7. Methods for generating synthetic videos are described with reference to FIGS. 8-10. A computing device configured to implement the video generation apparatus is described with reference to FIG. 11.

### Video Generation System

An apparatus for video generation is described. One or more aspects of the apparatus include at least one processor; at least one memory storing instructions executable by the at least one processor; and a video generation model comprising parameters stored in the at least one memory, wherein the video generation model includes a plurality of individually trained subnets trained to generate synthetic video data based on an input prompt and a target video resolution. Some examples of the apparatus, system, and method further include a layer of the video generation model comprises a residual block, a temporal attention block, a spatial attention block, and a cross-attention block. According to some aspects, the video generation model comprises a base diffusion model and a super-resolution model.

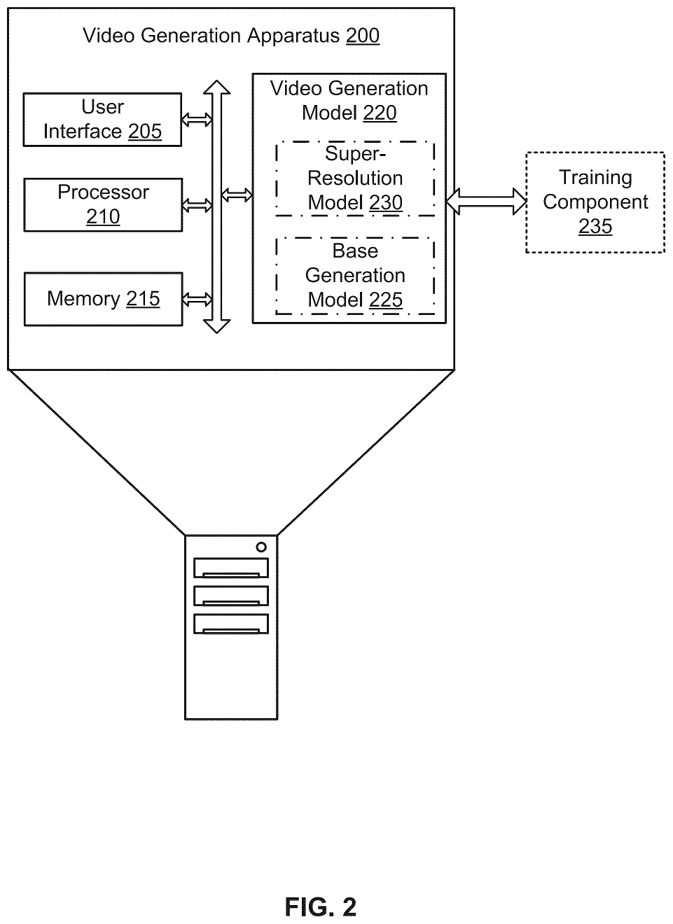

FIG. 1 shows an example of a video generation system according to aspects of the present disclosure. The example shown includes video generation apparatus 100, database 105, network 110, and user 115. Video generation apparatus 100 is an example of, or includes aspects of, the corresponding element described with reference to FIG. 2.

In the example shown, user 115 provides an input prompt describing the video they wish to generate, as well as a target generation time. Then, video generation apparatus 100 forms a subnet based on the target generation time, where the subnet includes model parameters from a parent video generation model. Video generation apparatus 100 then uses this subnet to generate a video depicting content from the input prompt, and provides the video to the user.

In some embodiments, one or more components of video generation apparatus 100 are implemented on a server. A server provides one or more functions to users linked by way of one or more of the available various networks, e.g. network 110. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

Database 105 stores information used by the video generation system, such as model parameters, saved subnets, training data, user profile information, and the like. A database is an organized collection of data. For example, a database stores data in a specified format known as a schema. A database may be structured as a single database 105, a distributed database, multiple distributed databases, or an emergency backup database. In some cases, a database controller may manage data storage and processing in the database. In some cases, a user interacts with the database controller. In other cases, the database controller may operate automatically without user interaction.

Network 110 facilitates the transfer of information between video generation apparatus 100, database 105, and user 115. Network 110 is sometimes referred to as a “cloud.” A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

FIG. 2 shows an example of a video generation apparatus 200 according to aspects of the present disclosure. The example shown includes video generation apparatus 200, user interface 205, processor 210, memory 215, video generation model 220, and training component 235. Video generation apparatus 200 is an example of, or includes aspects of, the corresponding element described with reference to FIG. 1.

A user interface 205 enables a user to interact with a device. For example, a user may enter inputs such as a text description and a target computation parameter via user interface 205. In some embodiments, user interface 205 includes an audio device, such as an external speaker system, an external display device such as a display screen, or an input device (e.g., remote control device interfaced with user interface 205 directly or through an IO controller module). In some cases, user interface 205 is or includes a graphical user interface (GUI).

A processor such as processor 210 is an intelligent hardware device, (e.g., a general-purpose processing component, a digital signal processor 210 (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor is configured to operate a memory array using a memory controller. In other cases, a memory controller is integrated into the processor. In some cases, the processor is configured to execute computer-readable instructions stored in a memory 215 to perform various functions. For example, processor 210 may be configured to propagate values between neural network layers, transforming the values by multiplying them by various weights, translating them with biases, and applying activation functions. In some embodiments, a processor includes special purpose components for modem processing, baseband processing, digital signal processing, machine learning (ML) model training and inference, or transmission processing.

Memory 215 stores information used by video generation apparatus 200, such as model parameters, code, and data. Memory 215 may load-in information from another source, such as a database. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

Some components of video generation apparatus 200 include one or more artificial neural network (ANN) components. An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

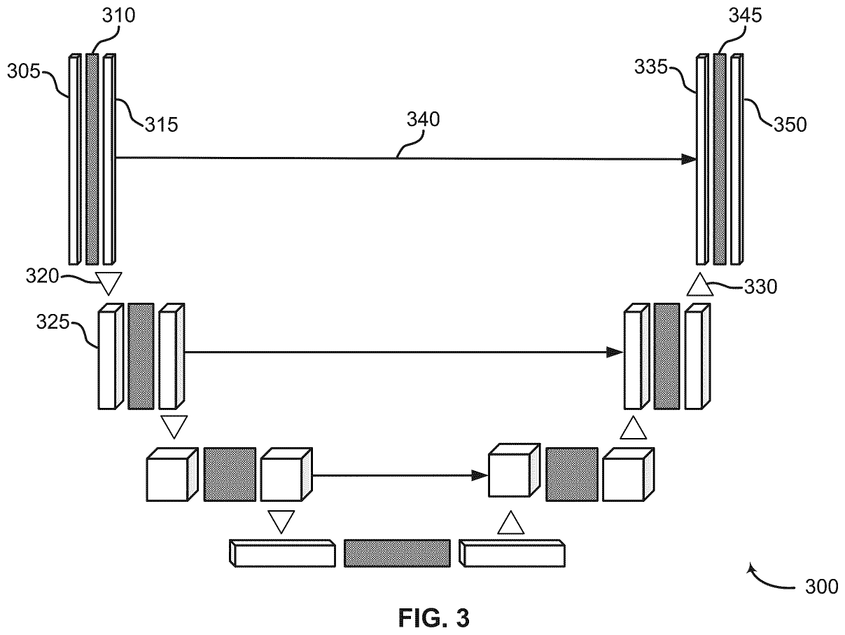

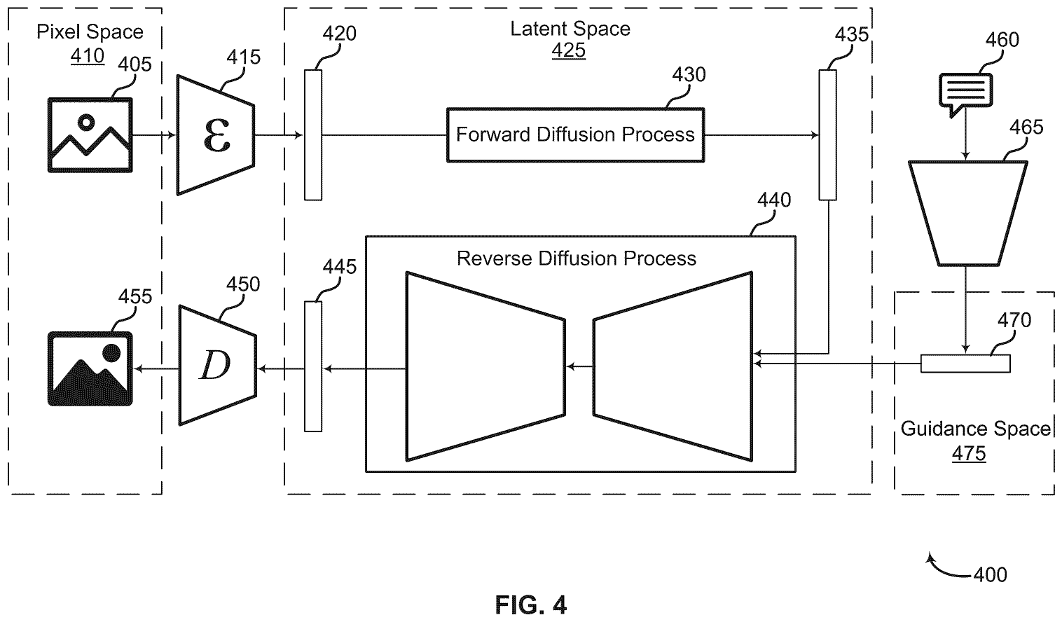

Video generation model 220 is configured to generate video. According to some aspects, the video generation process includes producing samples that resemble a distribution of training data. This does not necessarily limit the subject domains that are capable of being generated by the video generation model; it more so refers to the ability of the video generation model to transfer learned concepts such as recognizable visual features and plausible movements to the generated video. Embodiments of video generation model 220 include a diffusion model, though the present disclosure is not limited thereto. Other generative approaches such as vision transformers (ViT networks), GAN-based generators, and auto-encoders can be used, for example. An example of the architecture behind the diffusion model will be described with reference to FIG. 3. An example of the generative process will be described in further detail with reference to FIG. 4.

According to some aspects, the video generation model 220 is implemented with a framework that allows for the one-shot querying and selection of subnets for use with varying consumption restraints. This framework is referred to herein as a “superposition network architecture search for efficient diffusion” (SNED) framework, where “superposition” refers to the video generation model's ability to share weights across different subnets. This framework enables efficient utilization of computational resources by sharing weights among subnets, leading to optimized performance for varying computational constraints.

In some aspects, the video generation model 220 includes a base diffusion model 225 and a super-resolution model 230. The base diffusion model may be, for example, a generative diffusion model that is configured to generate video in a base resolution such as 256×256 or 512×512, and the super-resolution model 230 may be an upsampling network configured to upsample the video from the base diffusion model to higher resolutions. In some cases, the super-resolution model 230 is chosen based on a target resolution. In at least one embodiment, the super-resolution model 230 may be run repeatedly to repeatedly upsample the video to higher and higher resolutions. Video generation model 220 is an example of, or includes aspects of, the corresponding element described with reference to FIGS. 5 and 8.

Training component 235 is configured to prepare training data for video generation model 220 and to update parameters of video generation model 220 based on the training data. According to some aspects, training component 235 obtains a training set including a training video. In some examples, training component 235 samples a subnet architecture from an architecture search space. In some examples, training component 235 identifies a subset of the weights of the video generation model 220 based on the sampled subnet architecture. According to some aspects, the sampling is performed according to a dynamic cost sampling algorithm. In some examples, training component 235 trains, based on the training video, a subnet of the video generation model 220 to generate synthetic video data, where the subnet includes the subset of the weights of the video generation model 220.

In some examples, training component 235 obtains weights from a pre-trained image generation model. In some examples, during the sampling process, training component 235 selects a number of channels. In some examples, training component 235 selects one or more blocks within a layer of the video generation model 220. In some aspects, the one or more blocks are selected from a set including a residual block, a temporal attention block, a spatial attention block, and a cross-attention block. In some examples, training component 235 selects a video resolution, where the weights are selected based on the selected video resolution.

In some examples, training component 235 updates the subset of the weights based on a diffusion loss. In some examples, training component 235 freezes one or more weights of the video generation model 220 other than the subset of the weights corresponding to the subnet. In some examples, training component 235 iteratively selects a set of subnets based on the architecture search space. In some examples, training component 235 trains the set of subnets during a set of training iterations, respectively. In some examples, training component 235 progressively expands the architecture search space. In some aspects, the subnet architecture is sampled based on a dynamic cost algorithm. In some aspects, the subnet architecture is sampled based on a super-position algorithm. Training component 235 is an example of, or includes aspects of, the training component described with reference to FIG. 5. Additional detail regarding the subnet sampling processes and the training processes will be described with reference to FIG. 5.

FIG. 3 shows an example of a video generation architecture according to aspects of the present disclosure. The example shown includes U-Net 300, input features 305, initial neural network layer 310, intermediate features 315, down-sampling layer 320, down-sampled features 325, up-sampling process 330, up-sampled features 335, skip connection 340, final neural network layer 345, and output features 350.

In some examples, diffusion models are based on a neural network architecture known as a U-Net. The U-Net 300 takes input features 305 having an initial resolution and an initial number of channels, and processes the input features 305 using an initial neural network layer 310 to produce intermediate features 315. The initial neural network layer 310 may include a residual layer, a spatial self-attention layer, a spatial cross-attention layer, a temporal-attention layer, or a combination thereof. The intermediate features 315 are then down-sampled using a down-sampling layer 320 such that down-sampled features 325 features have a resolution less than the initial resolution and a number of channels greater than the initial number of channels.

This process is repeated multiple times, and then the process is reversed. That is, the down-sampled features 325 are up-sampled using up-sampling process 330 to obtain up-sampled features 335. The up-sampled features 335 can be combined with intermediate features 315 having a same resolution and number of channels via a skip connection 340. These inputs are processed using a final neural network layer 345 to produce output features 350. In some cases, the output features 350 have the same resolution as the initial resolution and the same number of channels as the initial number of channels.

In some cases, U-Net 300 takes additional input features to produce conditionally generated output. For example, the additional input features could include a vector representation of an input prompt. The additional input features can be combined with the intermediate features 315 within the neural network at one or more layers. For example, a cross-attention module can be used to combine the additional input features and the intermediate features 315.

FIG. 4 shows an example of a diffusion pipeline according to aspects of the present disclosure. The reverse diffusion process 440 is the main generative process for producing frames in a video. The example shown includes diffusion neural network 400, original image 405, pixel space 410, image encoder 415, original image features 420, latent space 425, forward diffusion process 430, noisy features 435, reverse diffusion process 440, denoised image features 445, image decoder 450, output image 455, text prompt 460, text encoder 465, guidance features 470, and guidance space 475.

In some examples, diffusion models are based on the U-Net neural network architecture. The U-Net takes input features having an initial resolution and an initial number of channels, and processes the input features using an initial neural network layer (e.g., a convolutional network layer) to produce intermediate features. The intermediate features are then down-sampled using a down-sampling layer such that down-sampled features have a resolution less than the initial resolution and a number of channels greater than the initial number of channels.

This process is repeated multiple times, and then the process is reversed. That is, the down-sampled features are up-sampled using up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features could include a vector representation of an input prompt. The additional input features can be combined with the intermediate features within the neural network at one or more layers. For example, a cross-attention module can be used to combine the additional input features and the intermediate features. Additional modules may be used in architectures adapted for video generation, such as temporal-attention modules. An example of a U-Net according to some embodiments is described with reference to FIG. 3.

A diffusion process may also be modified based on conditional guidance. In some cases, a user provides a text prompt describing content to be included in a generated image. For example, a user may provide the prompt “a person playing with a cat”. In some examples, guidance can be provided in a form other than text, such as via an image, a sketch, or a layout. The system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the system generates an image based on the noise map and the conditional guidance vector.

A diffusion process can include both a forward diffusion process for adding noise to an image (or features in a latent space) and a reverse diffusion process for denoising the images (or features) to obtain a denoised image. The forward diffusion process can be represented as q(xₜ|xₜ₋₁), and the reverse diffusion process can be represented as p(xₜ₋₁|xₜ). In some cases, the forward diffusion process is used during training to generate images with successively greater noise, and a neural network is trained to perform the reverse diffusion process (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process, the model begins with noisy data x_{T}, such as a noisy image and denoises the data to obtain the p(xₜ₋₁|xₜ). At each step t−1, the reverse diffusion process takes xₜ, such as first intermediate image, and t as input. Here, t represents a step in the sequence of transitions associated with different noise levels. The reverse diffusion process outputs xₜ₋₁, such as second intermediate image iteratively until x_{T} is reverted back to x₀, the original image. The reverse process can be represented as:

$${p}_{θ} ( {x}_{t - 1} \vert {x}_{t} ) := N ( {x}_{t - 1} ; {μ}_{θ} ( {x}_{t} , t ) , {Σ}_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T};0,I) is the pure noise distribution as the reverse process takes the outcome of the forward process, a sample of pure noise, as input and Πₜ₌₁^{T}p_{θ}(xₜ₋₁|xₜ) represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

A diffusion model may be trained using both a forward and a reverse diffusion process. In one example, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

The system then adds noise to a training image using a forward diffusion process in N stages. In some cases, the forward diffusion process is a fixed process where Gaussian noise is successively added to an image. In latent diffusion models, the Gaussian noise may be successively added to features in a latent space.

At each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

The training system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data. The training system then updates parameters of the model based on the comparison. For example, parameters of a U-Net may be updated using gradient descent. Time-dependent parameters of the Gaussian transitions can also be learned.

### Model Training

A method for video generation is described. One or more aspects of the method include obtaining a training set including a training video; initializing a video generation model; sampling a subnet architecture from an architecture search space; identifying a subset of weights of the video generation model based on the sampled subnet architecture; and training, based on the training video, a subnet of the video generation model to generate synthetic video data, wherein the subnet includes the subset of the weights of the video generation model. In some aspects, the subnet architecture is sampled based on a dynamic cost algorithm, e.g., during inference. In some aspects, the subnet architecture is sampled based on a super-position algorithm, e.g., during training or inference.

In some aspects, the training set includes an input prompt corresponding to the training video, wherein the subnet is trained based on the input prompt. Some examples further include obtaining weights from a pre-trained image generation model. Some examples further include selecting a number of channels for training. Some examples further include selecting one or more blocks within a layer of the video generation model for training. In some aspects, the one or more blocks are selected from a set including a residual block, a temporal attention block, a spatial attention block, and a cross-attention block. Some examples of the method, apparatus, non-transitory computer readable medium, and system further include selecting a video resolution.

Some examples of the method, apparatus, non-transitory computer readable medium, and system further include computing a diffusion loss based on an output of the video generation model and the training video. Some examples further include updating the subset of the weights based on the diffusion loss. Some examples further include freezing one or more weights of the video generation model other than the subset of the weights corresponding to the subnet. Some examples further include iteratively selecting a plurality of subnets based on the architecture search space. Some examples further include training the plurality of subnets during a plurality of training iterations, respectively. Some examples further include progressively expanding the architecture search space. Some examples of the method, apparatus, non-transitory computer readable medium, and system further include computing a moving average of a weight of the video generation model across the plurality of training iterations.

FIG. 5 shows an example of a training pipeline according to aspects of the present disclosure. The example shown includes training data 500, video generation model 520, and training component 530. Video generation model 520 is an example of, or includes aspects of, the corresponding element described with reference to FIGS. 2 and 8. Training component 530 is an example of, or includes aspects of, the corresponding element described with reference to FIG. 2.

In some examples, training component 530 selects a subnet 525 from the parameters of video generation model 520. The subnet 525 is selected according to a random set of attributes within a “search space.” An example of a search space is given by Table 1, below:

TABLE 1
Search space for each diffusion block such as
a downsampling or upsampling block of a U-Net.

| | |
|---|---|
| Percentage of Channels | {100%, 90%, 80%, 70%, 60%, 50%, 40%} |
| Fine-grained Blocks | {Residual Block, Spatial Self-attention, Spatial |
| | Cross-attention, Temporal-attention} |
| Resolution Options | [128 × 128, 256 × 256, 512 × 512} |

In this example, the search space includes 3 dimensions: a percentage of channels dimension, a fine-grained blocks dimension, and a resolution options dimension.

The parameters of subnet 525 are chosen based on this search space. During training, training component 530 compares the differences between the output video from subnet 525 and a target video from within training data 500. For example, the subnet 525 may be prompted to create a video based on a training prompt from training data 500, and the output video from subnet 525 may be compared to the video associated with the training prompt in the training data. A text encoder of the video generation model 520 may encode the prompt to enable text-conditioned generation. According to some aspects, the text encoder is pre-trained, and its weights are held fixed during the training of the video generation model 520. The training data 500 may include training videos with different resolutions. In one aspect, training data 500 includes high resolution training data 505, intermediate resolution training data 510, and low resolution training data 515. Training videos with the corresponding resolution to the selected subnet may be used when training the selected subnet. In at least some embodiments, the training component 530 preprocesses the training data based on the selected subnet, such as by transforming a resolution of the training data. According to some aspects, selecting training data appropriate for the currently selected subnet allows for lower memory usage during training.

According to some aspects, training component 530 quantifies the differences by computing a pixel-based loss such as an L2 loss, a feature-based loss, or a combination thereof. Then, training component 530 updates the parameters of subnet 525 based on the computed loss via e.g., backpropagation, while keeping remaining parameters of video generation model 520 frozen. This process may be repeated for other subnets corresponding to other points in the search space, e.g., as given by Algorithm 1:

Algorithm 1: Supernet Training

```
Input: Training iteration N, search space P, supernet S, loss function L,
training dataset
Dₜᵣₐᵢₙ, initial supernet weights W, candidate weights W_{P}, output
resolution R.
for i in N iterations do
  for data, labels in Dₜᵣₐᵢₙ do
    Randomly sample one subnet architecture and resolution R from
    search space P.
    Obtain the corresponding weights W_{P} from supernet weights W.
    Compute the gradients for training based on L.
    Update the corresponding W_{P} in W while freezing the rest of
    supernet S.
  end for
end for
```

Algorithm 1 describes an example training procedure according to some embodiments. According to some aspects, the architecture search space P is encoded into a supernet S, as denoted by S(P,W_{P}), where W_{P} is the weights of the supernet that are shared across all candidate architectures. The algorithm iteratively trains different subnets whose parameters are chosen according to the search space from Table 1. In some cases, the algorithm allows for a “superposition” framework, which refers to the feature of the supernet to have weights that can be used in multiple different trained subnets, as opposed to dedicating each weight to only a single subnet. After training, many different subnets may be chosen from a single supernet, the video generation model 520, based on a dynamic cost algorithm. The computation cost for inference may be pre-computed and corresponded to the various subnets that were trained during training.

In some embodiments, the training process includes a warmup phase, in which the search space for subnets is limited. For example, rather than determining the percentage of channels for each diffusion block from the set of {100%, 90%, 80%, 70%, 60%, 50%, 40%}, the percentage of channels will be 100%. According to some aspects, the warmup phase proceeds for a preconfigured number of training batches, such as 30000. Then, after the warmup phase, the search space will be gradually increased to include the other options shown in Table 1. For example, the minimum percentage of the channels and fine-grained blocks will be decreased from 100% to 40% in a step-schedule manner. According to some aspects, the warmup phase enables increased stability and model robustness during the remainder of the training.

In some embodiments of the training process, e.g., after a warmup phase has been completed, the training component selects an increasing percentage of channels in a progressive manner. For example, rather than randomly choosing a point in the search space, the training component will progressively choose 40% of channels per diffusion block, then 50%, and so forth. In some embodiments, the subnet chosen for a lower percentage of channels will be a strict subset of the parameters of the subnet chosen for a higher percentage of channels. For example, if a diffusion block is chosen to have 40% of its channels trained, then if that same diffusion block is chosen in a future training iteration to have 50% of its channels trained, then that 50% diffusion block will contain the same exact channels as the 40% block, with an additional 10% of channels selected for training. However, embodiments are not necessarily limited thereto, and various sets of parameters may be chosen according to different points in the search space at different training iterations, without necessarily building upon the same parameters of the smaller subnets.

In at least one embodiment, the training process further includes simultaneously training an exponential moving average (EMA) version of the image generation model. In some cases, during the training process of the video generation model 520 as described above, the training component 530 further trains an EMA model in parallel. After each training iteration of video generation model 520, the training component updates parameters of the EMA model by exponentially smoothing a copy of the weights of video generation model 520. The smoothing process assigns a higher weight to the most recent parameter updates while gradually diminishing the influence of past updates. During inference, either the trained video generation model 520 or the EMA model can be used. According to some aspects, maintaining an EMA model during training enables for a more accurate representation of performance for evaluation.

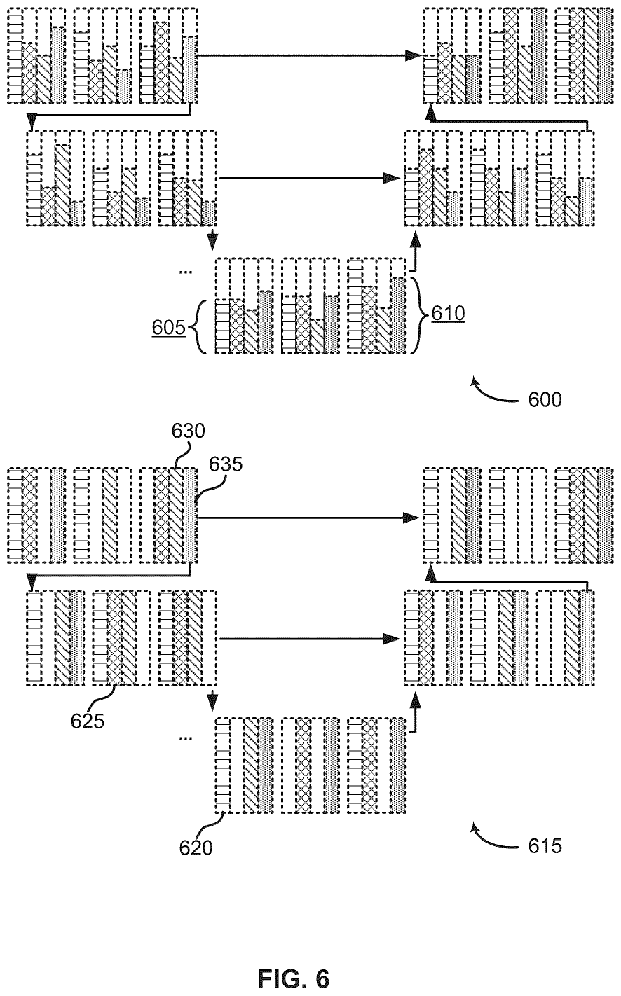

FIG. 6 shows an example of subnet sampling according to aspects of the present disclosure. The example shown includes first subnet 600, first number of channels 605, second number of channels 610, second subnet 615, residual block 620, temporal-attention block 625, spatial attention block 630, and cross-attention block 635.

First subnet 600 illustrates a set diffusion blocks with varying numbers of channels. For example, the numbers of channels illustrated by the bars with varying heights within each block may correspond to the different percentages of channels provided in the search space shown in Table 1. The first number of channels 605 may be 60% of the channels of a particular fine-grained block within the diffusion block, and the second number of channels 610 may be 90% of the channels of another fine-grained block within the diffusion block. In the example shown, a diffusion block includes 4 fine-grained blocks, such as a residual block, a spatial self-attention block, a spatial cross-attention block, and a temporal-attention block. In this example, first subnet 600 contains at least some parameters of all of the fine-grained blocks in every diffusion block. As used herein, the percentage of channels corresponds to the percentage of weights within a fine-grained block that are trained during the training iteration of the subnet, while remaining weights of the fine-grained block are held frozen.

Second subnet 615 illustrates a set of diffusion blocks with varying fine-grained blocks enabled within each diffusion block. For example, in the top-left downsampling layer, which contains three diffusion blocks, the first diffusion block of the layer omits a spatial attention block 630, the second diffusion block of the layer omits both a temporal-attention block 625 and a cross-attention block 635, and the third and final diffusion block of the layer omits a residual block 620. As used in this context, “omits” refers to the freezing of the parameters of the omitted fine-grained block during the training iteration of the subnet.

Some embodiments include a pixel-space video generation model, which performs the reverse diffusion process within the pixel-space rather than the latent space as described with reference to FIG. 4. In some cases, the pixel-space video generation model includes a base generation model and a super-resolution model (SSR). The base generation model and the SSR may each be created by choosing subsets of weights from the supernet model, i.e., the video generation model. In some embodiments, the base generation model and the chosen SSR are chosen from the same super-net, and are guided latent diffusion models. In some examples, the chosen SSR network is applied recursively to achieve different target resolutions. This contrasts with conventional super-resolution approaches that include multiple different SSR models. Accordingly, embodiments significantly reduce total model size.

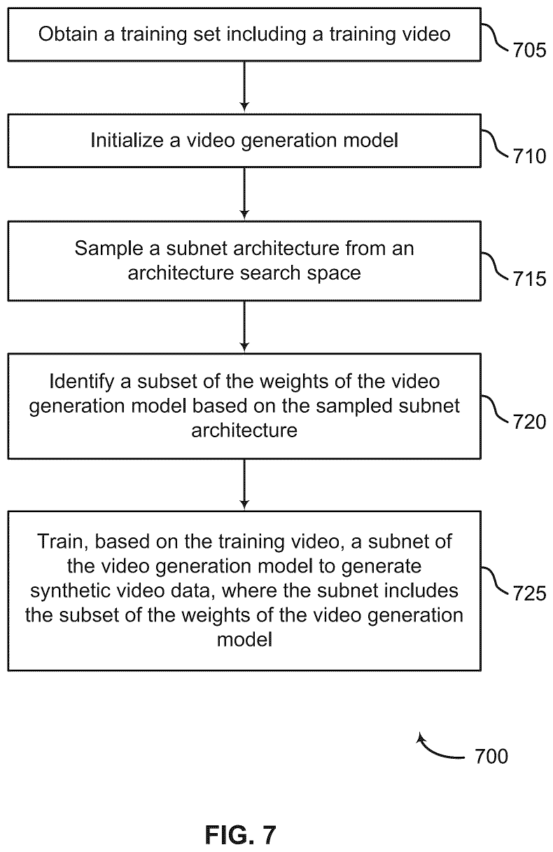

FIG. 7 shows an example of a method 700 for training a video generation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system obtains a training set including a training video. In some cases, the operations of this step refer to, or may be performed by, a training component as described with reference to FIGS. 2 and 5. The training set may include both a training video and a corresponding label to the training video, such as a prompt or description of the training video.

At operation 710, the system initializes a video generation model. In some cases, the operations of this step refer to, or may be performed by, a video generation apparatus as described with reference to FIGS. 1 and 2. In some embodiments, the initialization of the video generation model includes obtaining a pre-trained model, such as a diffusion-based image generation model. Then, the initialization may further include adjusting the architecture of the pre-trained model by adding temporal attention layers to diffusion blocks of the pre-trained model. In some embodiments, the initialization further includes adding a pre-trained text encoder to the video generation model.

At operation 715, the system samples a subnet architecture from an architecture search space. In some cases, the operations of this step refer to, or may be performed by, a training component as described with reference to FIGS. 2 and 5. For example, the training component may choose a point in a search space as shown in Table 1.

At operation 720, the system identifies a subset of the weights of the video generation model based on the sampled subnet architecture. In some cases, the operations of this step refer to, or may be performed by, a training component as described with reference to FIGS. 2 and 5. The training component may identify a subset of parameters of the video generation model corresponding to the chosen point in the search space. This identified set of parameters is the implementation of the subnet architecture. In some embodiments, the subnet architecture includes both a base generation model and a super-resolution model.

At operation 725, the system trains, based on the training video, a subnet of the video generation model to generate synthetic video data, where the subnet includes the subset of the weights of the video generation model. In some cases, the operations of this step refer to, or may be performed by, a training component as described with reference to FIGS. 2 and 5. In some embodiments, the training component computes a loss that quantifies the differences between the output synthetic video data from the subnet and the training video, and updates parameters corresponding to the subnet based on the loss.

### Generating Video

A method for video generation is described. One or more aspects of the method include obtaining an input prompt, a target video resolution, and a target performance parameter; selecting a subnet of a video generation model based on the target video resolution and the target performance parameter; and generating, using the subnet of the video generation model, synthetic video data based on the input prompt, wherein the synthetic video data has the target video resolution. Some examples of the method, apparatus, non-transitory computer readable medium, and system further include selecting a subset of channels and subset of blocks of the video generation model. In some aspects, the video generation model comprises a plurality of individually trained subnets including the selected subnet. According to some aspects, the video generation model shares parameters including weights and biases between multiple subnets.

FIG. 8 shows an example of an inference pipeline for video generation according to aspects of the present disclosure. The example shown includes video generation model 800, first resolution subnets 805, second resolution subnets 810, third resolution subnets 815, first resolution video 820, second resolution video 825, and third resolution video 830. Video generation model 800 is an example of, or includes aspects of, the corresponding element described with reference to FIGS. 2 and 5.

According to some aspects, embodiments can select different subnets from a video generation model 800 according to a dynamic cost sampling. In an example of dynamic cost sampling, the differentiation of computational costs across a plurality of available subnets is stored in a reference table. The plurality of available subnets may have an associated cost, and an associated set of parameters from the video generation model 800. In some cases, a chosen subnet may be deployed by masking parameters of video generation model 800 that are not associated with that subnet.

In this example, latent-space subnets, e.g., generative models configured to generate video data by performing reverse diffusion in a latent space, such as first resolution subnets 805, second resolution subnets 810, or third resolution subnets 815 are sampled for a particular target resolution. If a user desires to generate video of a first resolution, then the video generation system may deploy first resolution subnets 805 to generate first resolution video 820. If, however, the user desires to generate video of a higher resolution, such as the second resolution, then the video generation system may deploy second resolution subnets 810 to generate second resolution video 825. Similarly, to generate a highest resolution, the video generation system may deploy third resolution subnets 815 to generate third resolution video 830. The target computational usage may include additional parameters beyond target resolution, such as a target model size or a target inference time.

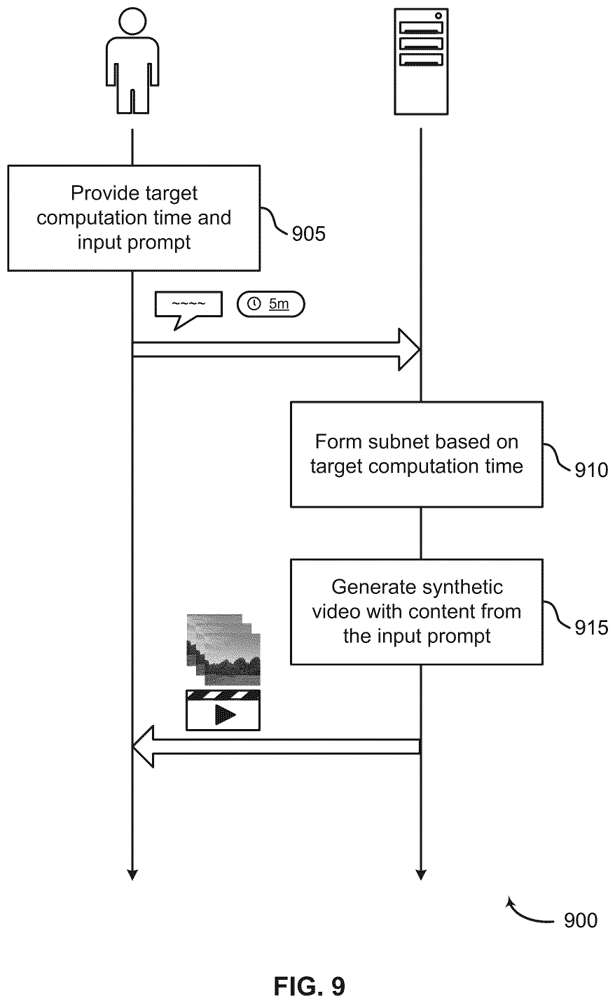

FIG. 9 shows an example of a method 900 for providing a video to a user with generation time constraints according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 905, the user provides target computation time and input prompt. For example, the user may enter the target computation time and the input prompt via a user interface as described with reference to FIG. 2. The input prompt may be a text description of the video the user wishes to generate. In this example, the target computation cost parameter is inference time, while other parameters, e.g. target resolution, video length, etc. may be preconfigured or held fixed.

At operation 910, the system forms a subnet based on the target computation time. For example, the system may determine a computational cost of each of a plurality of subnets that are available from a parent network, referred to as the video generation model. Then, the system chooses the subnet with the computational cost that will result in a generation time that is approximately equal to the time the user has specified. According to some aspects, the subnet is formed by masking parameters of the video generation model that are outside of the selected subnet. In at least one embodiment, multiple different subnets are deployed on one or more servers, and the subnet is formed by choosing one of the available subnets from the one or more servers.

At operation 915, the system generates synthetic video with content from the input prompt. For example, the system may generate the synthetic video using the formed subnet as the generative model. “Content” from the input prompt can refer to, e.g., background elements, actors, motions, scenic elements and lighting, and the like.

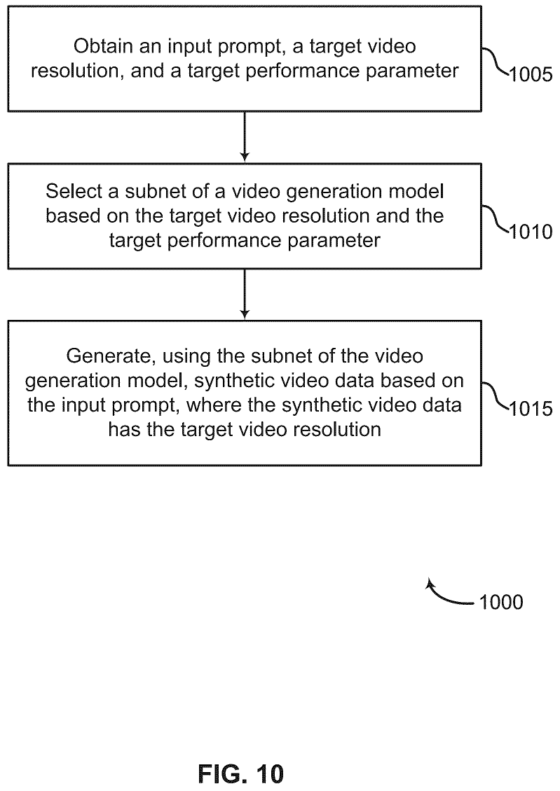

FIG. 10 shows an example of a method 1000 for generating a synthetic video according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, the system obtains an input prompt, a target video resolution, and a target performance parameter. In some cases, the operations of this step refer to, or may be performed by, a video generation apparatus as described with reference to FIGS. 1 and 2. The target performance parameter represents the desired performance of an instantiated video generation model. Examples of target performance parameters include a target inference time (i.e., a target total time for the generation process) and a target model size, though embodiments are not limited thereto.

At operation 1010, the system selects a subnet of a video generation model based on the target video resolution and the target performance parameter. In some cases, the operations of this step refer to, or may be performed by, a video generation model as described with reference to FIGS. 2, 5, and 8. For example, the system may select a subnet according to both the target video resolution and the target performance parameter. The subnet may be a fully functional generative model that is composed of a subset of parameters from the video generation model. In some examples, the subnet itself includes a plurality of models, such as a base generation model and a super-resolution model.

At operation 1015, the system generates, using the subnet of the video generation model, synthetic video data based on the input prompt, where the synthetic video data has the target video resolution. In some embodiments, the subnet generates the video with the target video resolution in one generative process. In at least one embodiment, the subnet includes both a base generation model and a super-resolution model, and the synthetic video data is generated by first generating a base video using the base generation model and then upsampling the base video one or more times using the super-resolution model to achieve the target video resolution.

FIG. 11 shows an example of a computing device 1100 configured to harmonize an image with a text according to aspects of the present disclosure. The example shown includes computing device 1100, processor(s) 1105, memory subsystem 1110, communication interface 1115, I/O interface 1120, user interface component(s) 1125, and channel 1130.

In some embodiments, computing device 1100 is an example of, or includes aspects of, video generation apparatus 100 of FIG. 1. In some embodiments, computing device 1100 includes one or more processors 1105 that can execute instructions stored in memory subsystem 1110 to obtain a training set including a training video; initialize a video generation model; sample a subnet architecture from an architecture search space; identify a subset of the weights of the video generation model based on the sampled subnet architecture; and train, based on the training video, a subnet of the video generation model to generate synthetic video data, wherein the subnet includes the subset of the weights of the video generation model.

According to some aspects, computing device 1100 includes one or more processors 1105. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1110 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1115 operates at a boundary between communicating entities (such as computing device 1100, one or more user devices, a cloud, and one or more databases) and channel 1130 and can record and process communications. In some cases, communication interface 1115 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1120 is controlled by an I/O controller to manage input and output signals for computing device 1100. In some cases, I/O interface 1120 manages peripherals not integrated into computing device 1100. In some cases, I/O interface 1120 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1020 or via hardware components controlled by the I/O controller.

According to some aspects, user interface component(s) 1125 enables a user to interact with computing device 1100. In some cases, user interface component(s) 1125 include an audio device, such as an external speaker system, an external display device such as a display screen, an input device (e.g., a remote control device interfaced with a user interface directly or through the I/O controller), or a combination thereof. In some cases, user interface component(s) 1125 include a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method of training a machine learning model, comprising:
obtaining a training set including a training video;
initializing a video generation model;
sampling a subnet architecture from an architecture search space;
identifying a subset of weights of the video generation model based on the sampled subnet architecture; and
training, based on the training video, a subnet of the video generation model to generate synthetic video data, wherein the subnet includes the subset of the weights of the video generation model.

2. The method of claim 1, wherein:
the training set includes an input prompt corresponding to the training video, wherein the subnet is trained based on the input prompt.

3. The method of claim 1, wherein initializing the video generation model comprises:
obtaining weights from a pre-trained image generation model.

4. The method of claim 1, wherein sampling the subnet architecture comprises:
selecting a number of channels.

5. The method of claim 1, wherein sampling the subnet architecture comprises:
selecting one or more blocks within a layer of the video generation model.

6. The method of claim 5, wherein:
the one or more blocks are selected from a set including a residual block, a temporal attention block, a spatial attention block, and a cross-attention block.

7. The method of claim 1, wherein sampling the subnet architecture comprises:
selecting a video resolution.

8. The method of claim 1, wherein training the subnet comprises:
computing a diffusion loss based on an output of the video generation model and the training video; and
updating the subset of the weights based on the diffusion loss.

9. The method of claim 1, wherein training the subnet comprises:
freezing one or more weights of the video generation model other than the subset of the weights corresponding to the subnet.

10. The method of claim 1, further comprising:
iteratively selecting a plurality of subnets based on the architecture search space; and
training the plurality of subnets during a plurality of training iterations, respectively.

11. The method of claim 10, wherein selecting the plurality of subnets comprises:
progressively expanding the architecture search space.

12. The method of claim 10, wherein training the plurality of subnets comprises:
computing a moving average of a weight of the video generation model across the plurality of training iterations.

13. The method of claim 1, wherein:
the subnet architecture is sampled based on a dynamic cost algorithm.

14. The method of claim 1, wherein:
the subnet architecture is sampled based on a super-position algorithm.

15. A method comprising:
obtaining an input prompt, a target video resolution, and a target performance parameter;
selecting a subnet of a video generation model based on the target video resolution and the target performance parameter; and
generating, using the subnet of the video generation model, synthetic video data based on the input prompt, wherein the synthetic video data has the target video resolution.

16. The method of claim 15, wherein selecting the subnet comprises:
selecting the subnet comprises: selecting a subset of channels and subset of blocks of the video generation model.

17. The method of claim 15, wherein:
the video generation model comprises a plurality of individually trained subnets including the selected subnet.

18. An apparatus comprising:
at least one processor;
at least one memory storing instructions executable by the at least one processor; and
the apparatus further comprising a video generation model comprising parameters stored in the at least one memory, wherein the video generation model includes a plurality of individually trained subnets trained to generate synthetic video data based on an input prompt and a target video resolution.

19. The apparatus of claim 18, further comprising:
a layer of the video generation model comprises a residual block, a temporal attention block, a spatial attention block, and a cross-attention block.

20. The apparatus of claim 18, wherein:
the video generation model comprises a base diffusion model and a super-resolution model.
